(19) United States
(12) Patent Application Publication
(10) Pub. No.: US 2016/0042153 A1
(43) Pub. Date: Feb. 11, 2016

(54) SYSTEM AND METHOD FOR RECEIVING, PROCESSING, AND PRESENTING NUTRITION-RELATED INFORMATION

(71) Applicant: WELLSEEK, INC., San Diego, CA (US)

(72) Inventor: Monica Lijia Mo, San Diego, CA (US)

(21) Appl. No.: 14/819,278

(22) Filed: Aug. 5, 2015

Related U.S. Application Data
(60) Provisional application No. 62/034,086, filed on Aug. 6, 2014.

(51) Int. Cl. G06F 19/00; G06F 17/30

(52) U.S. Cl. CPC G06F 19/3475; G06F 17/3053; G06F 17/30241; G06F 17/30554

(57) ABSTRACT

A device may acquire information associated with an age, a gender, a weight, a height, and one or more lifestyle factors of a user. The device may also receive a nutrition inquiry of the user. The device may also compute a recommended daily amount of one or more nutrients for consumption by the user based on the received nutrition inquiry and at least a portion of the acquired information. The device may also determine information indicating a health benefit of the one or more nutrients and information indicating a health detriment associated with a deficiency or excess of the one or more nutrients and display the determined information. The device may also generate a ranked list of a plurality of foods that contain the one or more nutrients, wherein the list may be ranked according to a recommended percent daily value for the one or more nutrients.

### CROSS-REFERENCE TO RELATED APPLICATION

This application claims priority to and benefit of provisional patent application No. 62/034,086 filed in the United States Patent and Trademark Office on Aug. 6, 2014, the entire contents of which is hereby incorporated herein by reference.

### INTRODUCTION

Information related to nutrition is often scattered throughout various sources and not readily accessible to a user. A consumer that seeks information related to nutrition may need to expend substantial time and energy to research that information using various sources. As such, the consumer may sometimes become discouraged, disengaged, and/or unable to readily access the nutrition-related information that they seek. Additionally, some nutrition experts may encounter similar problems when seeking nutrition-related information in furtherance of their occupations. For example, some nutrition experts may wish to access nutrition-related information in order to devise appropriate nutrition interventions for their clients/patients. Existing systems may not adequately help nutrition experts efficiently gather information for their clients. As such, nutrition experts using existing systems may need to expend a substantial amount of time to research and personalize food options and other nutrition-related information for their clients. Accordingly, many people can benefit from enhanced systems that overcome such limitations to provide an improved experience when seeking nutrition-related information.

### SUMMARY OF SOME EMBODIMENTS

Various aspects of methods, apparatuses, and computer-readable medium are described throughout the present disclosure. The following description provides various non-limiting examples and is not intended to limit the scope of the present disclosure.

In an aspect, the present disclosure provides an apparatus for providing nutrition-related information to a user. The apparatus may include at least one processor and a memory communicatively coupled to the at least one processor. The at least one processor may be configured to acquire information associated with an age, a gender, a weight, a height, and one or more lifestyle factors of a user. The at least one processor may be further configured to receive a nutrition inquiry of the user. The at least one processor may be further configured to compute a recommended daily amount of one or more nutrients for consumption by the user based on the received nutrition inquiry and at least a portion of the acquired information. The at least one processor may be further configured to determine information indicating a health benefit of the one or more nutrients and information indicating a health detriment associated with a deficiency or excess of the one or more nutrients and to display the determined information. The at least one processor may be further configured to generate a ranked list of a plurality of foods that contain the one or more nutrients, wherein the list is ranked according to a recommended percent daily value for the one or more nutrients. The at least one processor may be further configured to determine location information associated with one or more of the plurality of foods in relation to a location corresponding to the user.

In another aspect, the present disclosure provides a method of providing nutrition-related information to a user. The method may include acquiring information associated with an age, a gender, a weight, a height, and one or more lifestyle factors of a user. The method may further include receiving a nutrition inquiry of the user. The method may further include computing a recommended daily amount of one or more nutrients for consumption by the user based on the received nutrition inquiry and at least a portion of the acquired information. The method may further include determining information indicating a health benefit of the one or more nutrients and information indicating a health detriment associated with a deficiency or excess of the one or more nutrients and displaying the determined information. The method may further include generating a ranked list of a plurality of foods that contain the one or more nutrients, wherein the list is ranked according to a recommended percent daily value for the one or more nutrients. The method may further include determining location information associated with one or more of the plurality of foods in relation to a location corresponding to the user.

In yet another aspect, the present disclosure provides a computer-readable medium including computer-executable instructions. The computer-readable medium may be configured to acquire information associated with an age, a gender, a weight, a height, and one or more lifestyle factors of a user. The computer-readable medium may be further configured to receive a nutrition inquiry of the user. The computer-readable medium may be further configured to compute a recommended daily amount of one or more nutrients for consumption by the user based on the received nutrition inquiry and at least a portion of the acquired information. The computer-readable medium may be further configured to determine information indicating a health benefit of the one or more nutrients and information indicating a health detriment associated with a deficiency or excess of the one or more nutrients and to display the determined information. The computer-readable medium may be further configured to generate a ranked list of a plurality of foods that contain the one or more nutrients, wherein the list is ranked according to a recommended percent daily value for the one or more nutrients. The computer-readable medium may be further configured to determine location information associated with one or more of the plurality of foods in relation to a location corresponding to the user.

In a further aspect, the present disclosure provides another apparatus for providing nutrition-related information to a user. The apparatus may include means for acquiring information associated with an age, a gender, a weight, height, and one or more lifestyle factors of a user. The apparatus may further include means for receiving a nutrition inquiry of the user. The apparatus may further include means for computing a recommended daily amount of one or more nutrients for consumption by the user based on the received nutrition inquiry and at least a portion of the acquired information. The apparatus may further include means for determining information indicating a health benefit of the one or more nutrients and information indicating a health detriment associated with a deficiency or excess of the one or more nutrients and displaying the determined information. The apparatus may further include means for generating a ranked list of a plurality of foods that contain the one or more nutrients, wherein the list is ranked according to a recommended percent daily value for the one or more nutrients. The apparatus may further include means for determining location information associated with one or more of the plurality of foods in relation to a location corresponding to the user.

The foregoing is merely a summary of various features described in greater detail herein. Additional features are also described herein. The embodiments described herein may be implemented in any combination or sub-combination, even if not explicitly described herein. These and other aspects of the present disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures.

### BRIEF DESCRIPTION OF DRAWINGS

FIG. 1 is a diagram illustrating an example of communications between devices according to various aspects of the present disclosure.

FIG. 2 is a diagram illustrating an example of devices in a home environment according to various aspects of the present disclosure.

FIGS. 3-12 are diagrams illustrating examples of many aspects that may be provided to a user of a device according to various aspects of the present disclosure.

FIGS. 13-15 are diagrams illustrating an example of methods and/or processes performed by a device according to various aspects of the present disclosure.

FIG. 16 is a diagram illustrating an example of a hardware implementation of a device according to various aspects of the present disclosure.

### DESCRIPTION OF SOME EMBODIMENTS

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

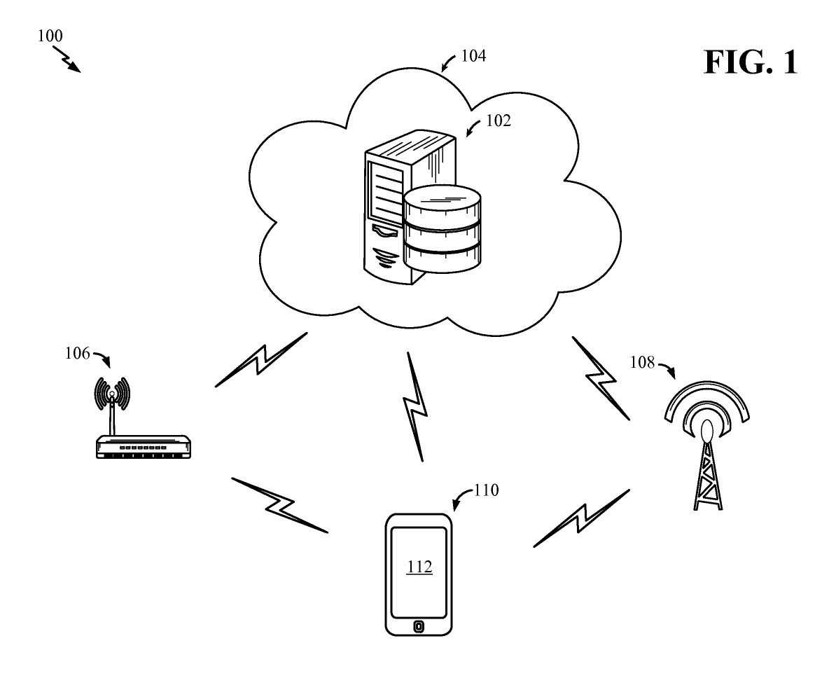

FIG. 1 is a diagram 100 illustrating an example of various communications between devices according to various aspects of the present disclosure. For illustrative purposes, the server device may be a server 102. For illustrative purposes, the client device may be a smartphone 110. The smartphone 110 may have a built-in display 112. Although not illustrated in FIG. 1, alternative examples of client devices may include desktop computers, laptop computers, tablet computers, set top boxes (e.g., connected to a television), wearable devices (e.g., glasses, watches, etc.), and various other suitable devices. Although the non-limiting example illustrated in FIG. 1 shows one client device, one of ordinary skill in the art will understand that any number of client devices may be implemented without deviating from the scope of the present disclosure. The server device may be located locally (e.g., within the same network and/or physical location) or remotely (e.g., within a different network and/or physical location) in relation to the client devices. For example, the server device may be associated with an Internet-based (e.g., “cloud”-based) computing environment 104. Communications between the client devices and the server device may be performed via a wired connection and/or a wireless connection. Such communications may be performed using various types of technologies without deviating from the scope of the present disclosure. One of ordinary skill in the art will understand that various types of communication technologies may be used without deviating from the scope of the present disclosure. Without deviating from the scope of the present disclosure, such communications may be facilitated by various other computers, servers, gateways, routers, and other hardware devices, even if not illustrated in FIG. 1.

In some configurations, the server device may communicate with a first client device via a first network, and the server device may also communicate with a second client device via a second network (that is different from the first network). For example, the server 102 may communicate with the smartphone 110 via a local area network (LAN) that utilizes a wireless access point (AP) 106, and the server 102 may also communicate with the smartphone 110 via a cellular network that utilizes an access node 108. The LAN may implement various types of technologies without deviating from the scope of the present disclosure. For example, the LAN may implement protocols and/or algorithms that comply with various communication standards of the Institute of Electrical and Electronics Engineers (IEEE), such as IEEE 802.11. The cellular network may implement various types of technologies without deviating from the scope of the present disclosure. For example, the cellular network may implement protocols and/or algorithms that comply with various communication standards of the Third Generation Partnership Project (3GPP) and 3GPP2, such as 3G and 4G (Long Term Evolution), and of the Next Generation Mobile Networks (NGMN) Alliance, such as 5G.

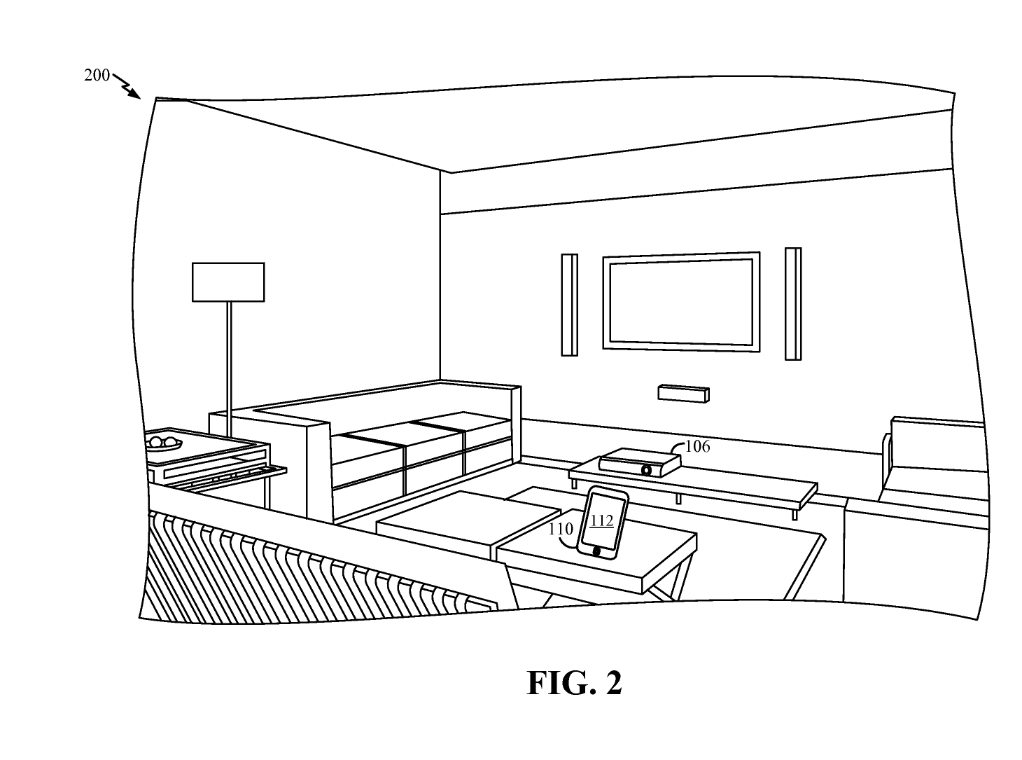

FIG. 2 is a diagram 200 illustrating an example of some devices in a home environment according to various aspects of the present disclosure. In the example illustrated in FIG. 2, the client device is a smartphone 110 with a built-in display 112, and the smartphone is in communication with an access point 106. Additional description pertaining to such aspects is provided above with reference to FIG. 1 and therefore will not be repeated here. Although the example illustrated in FIG. 2 depicts a home environment, one of ordinary skill in the art will readily understand that the home environment is not a limitation of the present disclosure. Aspects of the present disclosure may be implemented in various types of environments (e.g., outdoor environments, office/work environments, etc.) without deviating from the scope of the present disclosure.

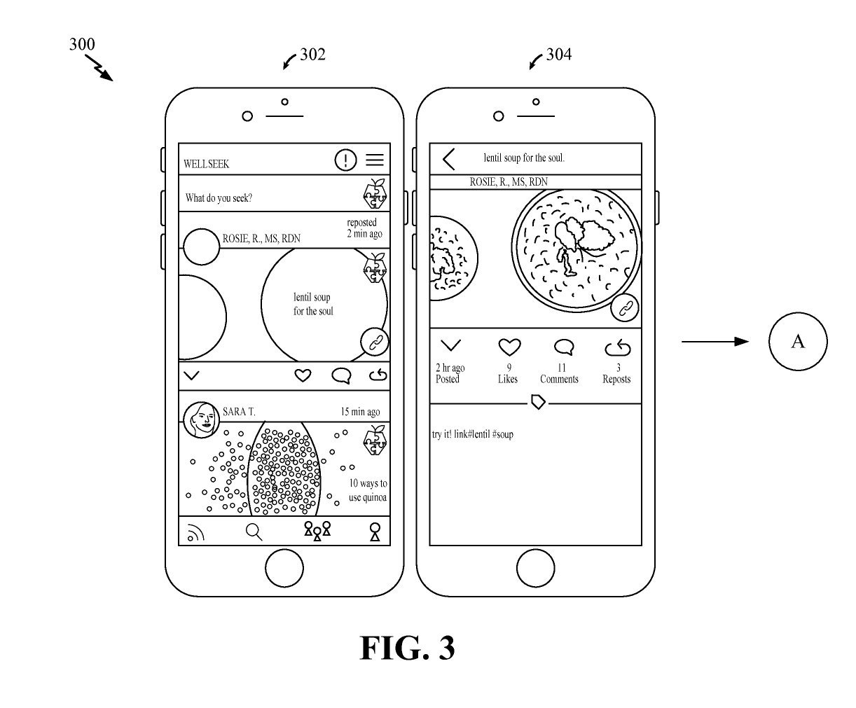

FIG. 3 is a diagram 300 illustrating an example of various aspects that may be provided to a user of the client device (e.g., the smartphone 110). In an aspect 302, the client device may display a news feed. The news feed may provide the user with continuously updating content associated with nutrition. The content associated with nutrition may include news, articles, blog posts, and any other suitable information associated with nutrition. In some configurations, the content associated with nutrition may be retrieved from a server, a website, a database, or other suitable source of information associated with nutrition. In some configurations, the content associated with nutrition may be provided by nutritionists, such as registered dietitian nutritionists (RDNs), or any other suitable person or entity that provides information associated with nutrition. For example, as illustrated in an aspect 302 of FIG. 3, one content may be titled, “lentil soup for the soul,” and another content may be titled, “10 ways to use quinoa.” If the user selects the content titled “lentil soup for the soul,” the user may be provided with the display shown in an aspect 304 of FIG. 3. In the aspect 304 illustrated in FIG. 3, the user is provided more information pertaining to that selected content. For example, the user may view the recipe associated with “lentil soup for the soul,” and the user may have various other options for communicating and commenting about that content (“lentil soup for the soul”). For instance, the user may “like” that content, comment on that article, repost that content, and other suitable actions associated with that content.

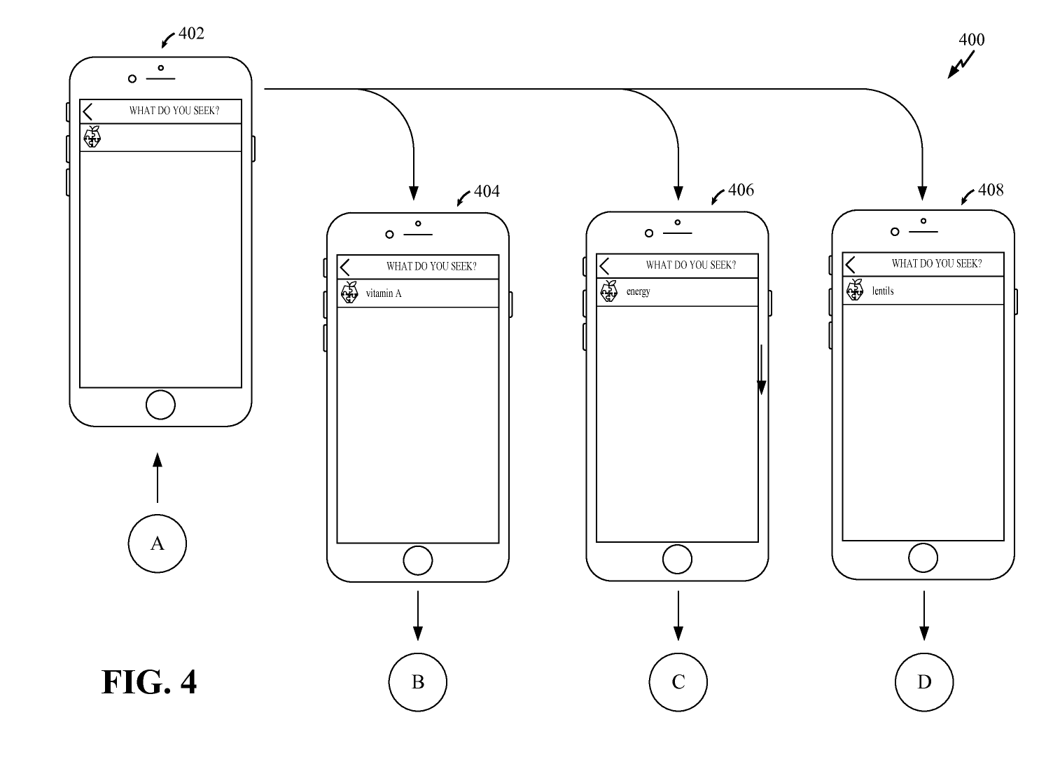

FIG. 4 is a diagram 400 illustrating an example of search operations that may be performed according to various aspects of the present disclosure. As also illustrated in the aspects 302, 304 illustrated in FIG. 3, the user may be provided with a search bar, which may be locate adjacent to an icon (e.g., a “Seek It” icon). In some configurations, selecting that icon (e.g., the “Seek It” icon) may trigger the search operations described herein (e.g., with reference to FIG. 4). As illustrated in an aspect 402 of FIG. 4, the search operations may include a blank/empty search bar. As illustrated in an aspect 404 of FIG. 4, the blank/empty search bar may be filled in with the term “vitamin A.” In other words, the user may be seeking nutrition information associated with vitamin A. As illustrated in an aspect 406 of FIG. 4, the blank/empty search bar may be filled in with the term “energy.” In other words, the user may be seeking nutrition information associated with energy. As illustrated in an aspect 408 of FIG. 4, the blank/empty search bar may be filled in with the term “lentils.” In other words, the user may be seeking nutrition information associated with lentils.

In some configurations, the user may fill-in/populate the otherwise blank/empty search bar with a desired search term(s). In some configurations, the otherwise blank/empty search bar may be automatically filled-in/populated based on a user selection. For example, the user may select the content titled, “lentil soup for the soul,” as shown in an aspect 304 of FIG. 3. That content may include metadata that links the content to the search term “lentils.” If the user selects the aforementioned icon (e.g., the “Seek It” icon), which may be provided on or adjacent to that content, then the user may be provided with the aspect 408 illustrated in FIG. 4, which illustrates an example of the search term “lentils” being included in the otherwise blank/empty search bar. As mentioned above, this process may be performed automatically based using various techniques without deviating from the scope of the present disclosure.

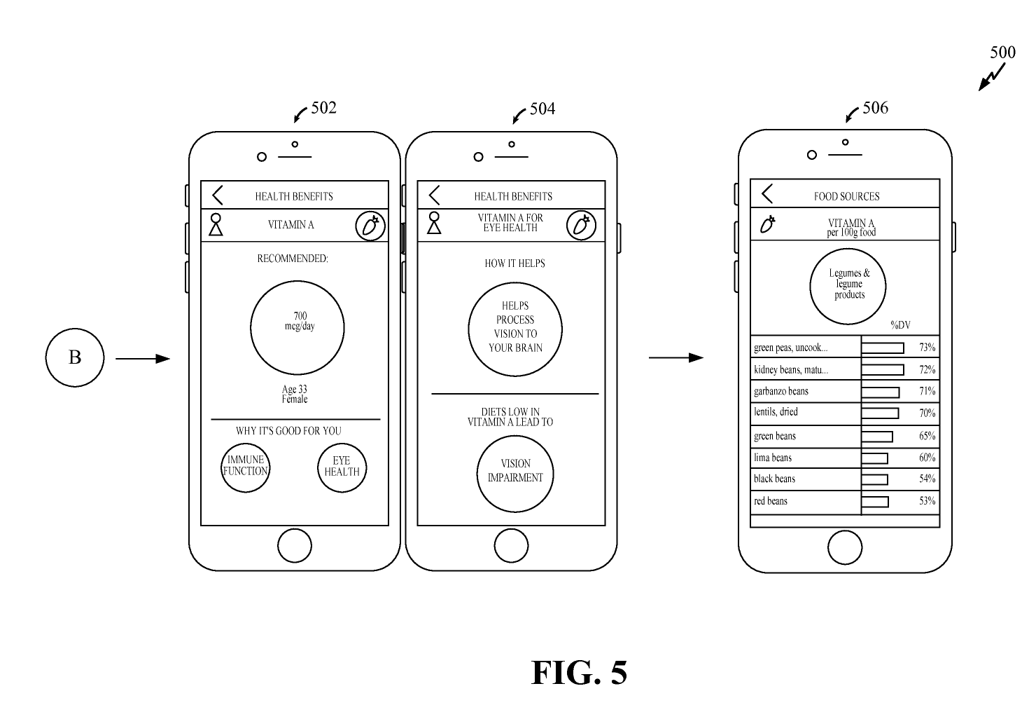

FIG. 5 is a diagram 500 illustrating an example of various aspects that may be provided to the user of the client device according to various aspects of the present disclosure. As mentioned above, in some configurations, the user may seek information associated with vitamin A. As illustrated in an aspect 502 of FIG. 5, the user may be provided with a recommended daily amount of vitamin A (e.g., 700 mcg/day) based on the age, gender, and various other factors associated with the user. As also illustrated in an aspect 502 of FIG. 5, the user may also be provided with health benefits associated with the relevant nutrient (e.g., vitamin A). For example, the user may be provided with information indicating that vitamin A is “good for you” because it may provide health benefits with regard to “immune function” and/or “eye health,” as illustrated in an aspect 502 of FIG. 5. The health benefits displayed to the user may be selectable. In other words, the user may seek additional information related to the health benefit of “eye health” and, thus, may select the information indicating “eye health.” By doing so, as illustrated in an aspect 504 of FIG. 5, the user is provided with more detailed information associated with the health benefits of “eye health.” For example, the user may be provided with information about “how it helps” (e.g., “helps process vision to your brain”) and information about what “diets low in vitamin A [can] lead to” (e.g., “vision impairment”). Such information may be retrieved from a database, may be queried from an expert (e.g., an RDN), or obtained from any other suitable source using any suitable technique without deviating from the scope of the present disclosure.

In some configurations, the user may be provided with an icon (e.g., the carrot-shaped icon shown in the upper-right corner of the aforementioned aspects 502, 504). This icon may be selectable by the user. If the user seeks information associated with foods that may contain one or more of the nutrients associated with the content displayed to the user, the user may select that icon (e.g., the carrot-shaped icon shown in the upper-right corner of the aforementioned aspects 502, 504). After selecting that icon, the user may be provided with information associated with one or more foods that contain that/those one or more nutrients. For example, as illustrated in an aspect 506 of FIG. 5, the user may be provided with a ranked list of a plurality of foods (e.g., green peas, kidney beans, garbanzo beans, lentils, green beans, lima beans, black beans, red beans) that contain one or more nutrients (e.g., vitamin A). In some configurations, the list may be ranked according to a recommended percentage daily value (% DV) for the one or more nutrients (e.g., vitamin A). For example, garbanzo beans may be ranked higher in the list relative to the ranking of lentils in the list, because 71% DV of vitamin A in 100 grams of garbanzo beans is greater than the 70% DV of vitamin A in 100 grams of lentils. Although the example illustrated an aspect 506 of FIG. 5 shows a ranked list based on a descending % DV associated with each food, one of ordinary skill in the art will understand that the ranked list may be provided in any other ranking configuration without deviating from the scope of the present disclosure.

In some configuration, the list is ranked according to a first set of one or more nutrients for which an increased consumption is recommended and a second set of one or more nutrients for which a decreased daily consumption is recommended. The first set may include one or more nutrients for which the increase or maximization thereof may provide health benefits to the user. An example of such a nutrient is potassium (K). The second set may include one or more nutrients for which the reduction or minimization thereof may provide health benefits to the user. An example of such a nutrient is sugar. Various mathematical equations and/or software algorithm may be implemented to achieve the desired outcome of increasing/maximizing the first set of one or more nutrients while reducing/minimizing the second set of one or more nutrients. An example of a pseudo-code that may implement such an outcome may be: max(first set of one or more nutrients) AND min(second set of one or more nutrients).

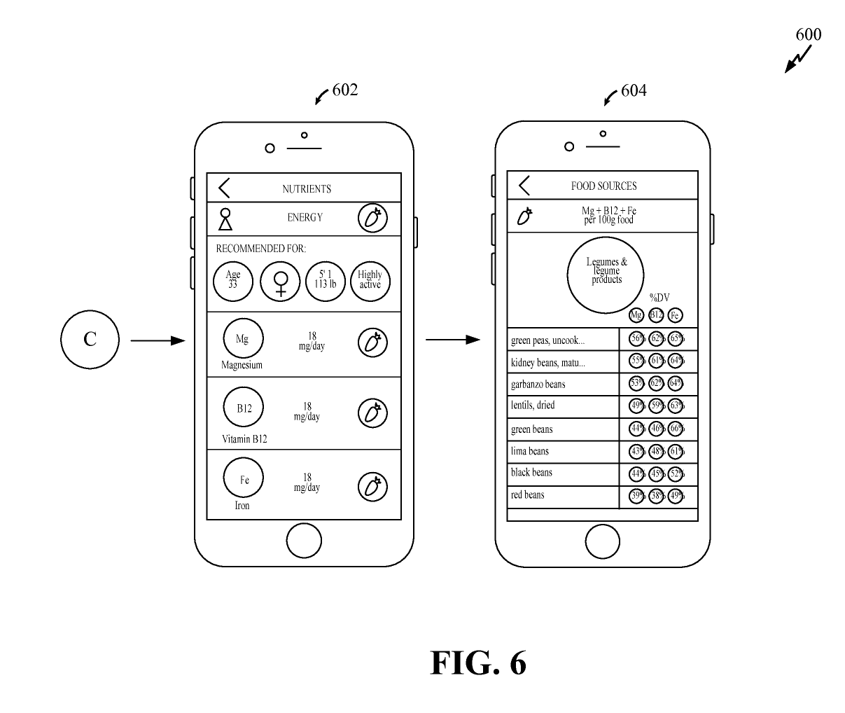

FIG. 6 is a diagram 600 illustrating an example of various aspects that may be provided to the user of the client device according to various aspects of the present disclosure. As described above with respect to an aspect 406 of FIG. 4, in some circumstances, the user may seek information associated with the search term “energy.” Under such circumstances, the user may be provided with certain recommendations based on at least one of age, gender, weight, height, or one or more lifestyle factors (e.g., an activity level) of the user. For instance, with regard to “energy,” the user may be provided with a recommended daily amount of one or more nutrients based on the age, gender, weight, height, and one or more lifestyle factors (e.g., activity level) of the user. If the user is 33 years old, is a female, weighs 113 lbs, is 5′ 1″, and is highly active, the user may be provided with a recommended daily amount of 18 mg/day of magnesium (Mg), 18 mg/day of vitamin B12, and 18 mg/day of iron (Fe). One of ordinary skill in the art will understand that the specific/numeric recommended daily amounts described herein and illustrated in the drawings are provided for illustrative purposes only and are shall not be construed as medical advice nor technical limitations of the present disclosure. Furthermore, although three nutrients (e.g., Mg, vitamin B12, Fe) are shown in an aspect 602 of FIG. 6, one of ordinary skill in the art will understand that any suitable number of nutrients may be implemented without deviating from the scope of the present disclosure.

In an aspect 604 of FIG. 6, the user may be provided with a ranked list according to an average of the recommended percent daily value for two or more nutrients. This aspect 604 of FIG. 6 may be compared to the aspect 506 of FIG. 5, which showed a ranked list of a single nutrient (e.g., vitamin A) for a plurality of foods (e.g., green peas, kidney beans, garbanzo beans, lentils, green beans, lima beans, black beans, red beans). In the aforementioned aspect 604 of FIG. 6, the list of foods is ranked according to the recommended percent daily value for Mg, vitamin B12, and Fe. For example, lentils is ranked higher in the list relative to the ranking of green beans, because the average of the recommended daily values for the three nutrients (Mg, vitamin B12, and Fe) in lentils (e.g., average of 49%, 59%, and 63% is 57%) is greater than the average of the recommended daily values for the three nutrients in green beans (e.g., average of 44%, 46%, and 66% is 52%), even though at least one of the recommended daily values (e.g., Fe) is higher in green beans (e.g., 66%) relative to lentils (e.g., 63%). By showing the information associated with a plurality of nutrients (e.g., Mg, vitamin B12, and Fe) for each of the foods (e.g., green peas, kidney beans, garbanzo beans, lentils, green beans, lima beans, black beans, red beans), the user is able to intelligently evaluate which of the foods may provide the greatest overall health benefit, the user is able to quantitatively compare the nutritional content of one food relative to another food.

In some configuration, the list is ranked according to a first set of one or more nutrients for which an increased consumption is recommended and a second set of one or more nutrients for which a decreased daily consumption is recommended. The first set may include one or more nutrients for which the increase or maximization thereof may provide health benefits to the user. An example of such a nutrient is potassium (K). The second set may include one or more nutrients for which the reduction or minimization thereof may provide health benefits to the user. An example of such a nutrient is sugar. Various mathematical equations and/or software algorithm may be implemented to achieve the desired outcome of increasing/maximizing the first set of one or more nutrients while reducing/minimizing the second set of one or more nutrients. An example of a pseudo-code that may implement such an outcome may be: max(first set of one or more nutrients) AND min(second set of one or more nutrients).

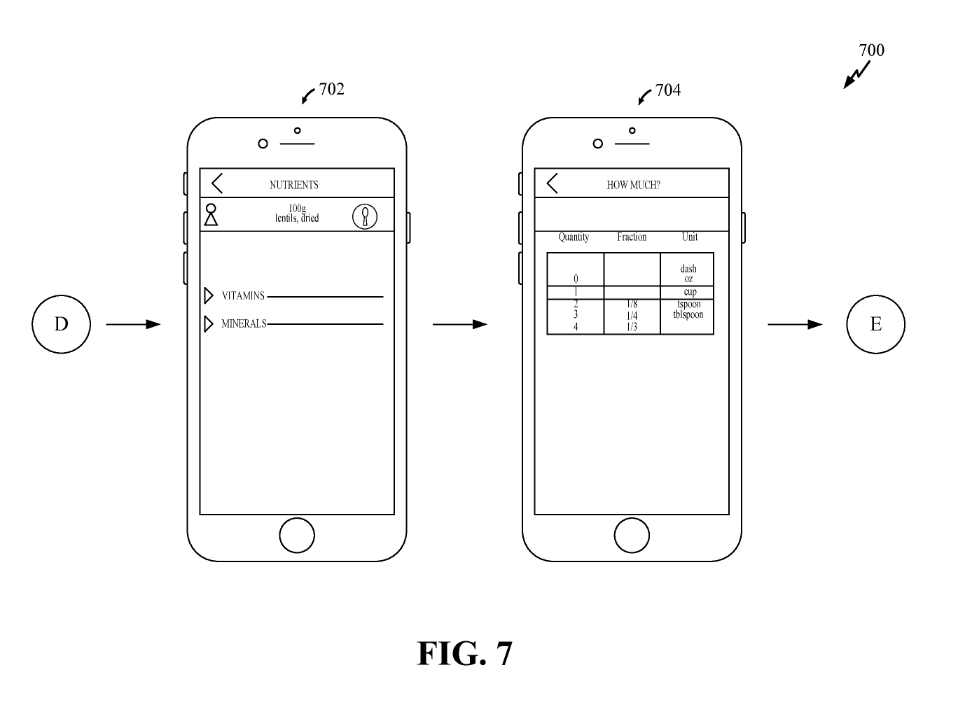

FIG. 7 is a diagram 700 illustrating an example of various aspects that may be provided to the user of the client device according to various aspects of the present disclosure. As described above with respect to an aspect 408 of FIG. 4, in some circumstances, the user may seek information associated with the search term “lentils.” Under such circumstances, as illustrated in an aspect 702 of FIG. 7, the user may be provided with an opportunity to view the vitamins and/or mineral contents of that food (e.g., lentils). To calculate the amount of vitamins and/or minerals in the food (e.g., lentils), the user may be provided with an opportunity to enter the amount of that food (e.g., lentils), as illustrated in an aspect 704 of FIG. 7. For example, the user may be able to enter the quantity (e.g., integer values and/or fractions) as well as the unit (e.g., dash, ounce, cup, teaspoon, tablespoon, etc.) associated with that amount of food (e.g., lentils), as also illustrated in an aspect 704 of FIG. 7.

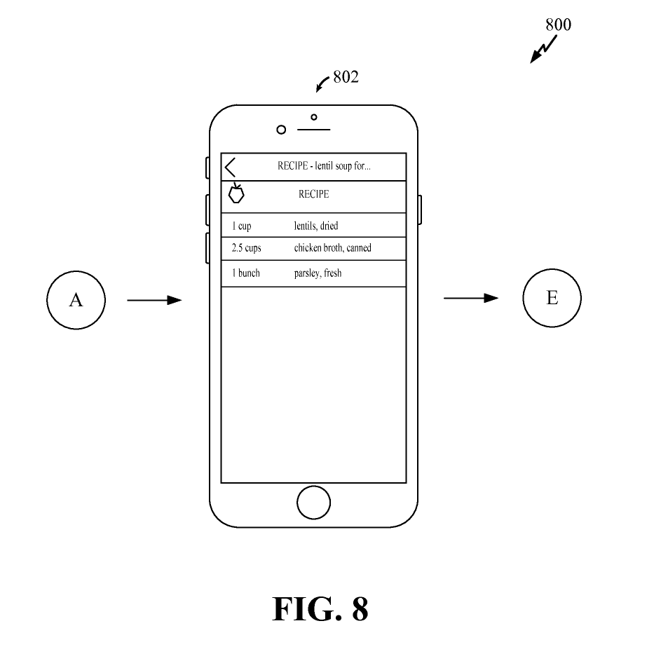

FIG. 8 is a diagram 800 illustrating an example of various aspects that may be provided to the user of the client device according to various aspects of the present disclosure. As described above with respect to an aspect 410 of FIG. 4, in some circumstances, the user may select one of the contents (e.g., news, articles, blog posts, and any other suitable information associated with nutrition) shown in a news feed (e.g., the news feed described above in aspects 302, 304 of FIG. 3). Under such circumstances, the user may be provided with the recipe associated with that selected content. For example, referring to an aspect 302 of FIG. 3, the user may select the content titled “lentil soup for the soul.” In response to such a selection, the user may be provided with the recipe associated with that content (e.g., “lentil soup for the soul”). For example, as illustrated in an aspect 802 of FIG. 8, the recipe may include 1 cup of lentils, 2.5 cups of chicken broth, and 1 bunch of parsley.

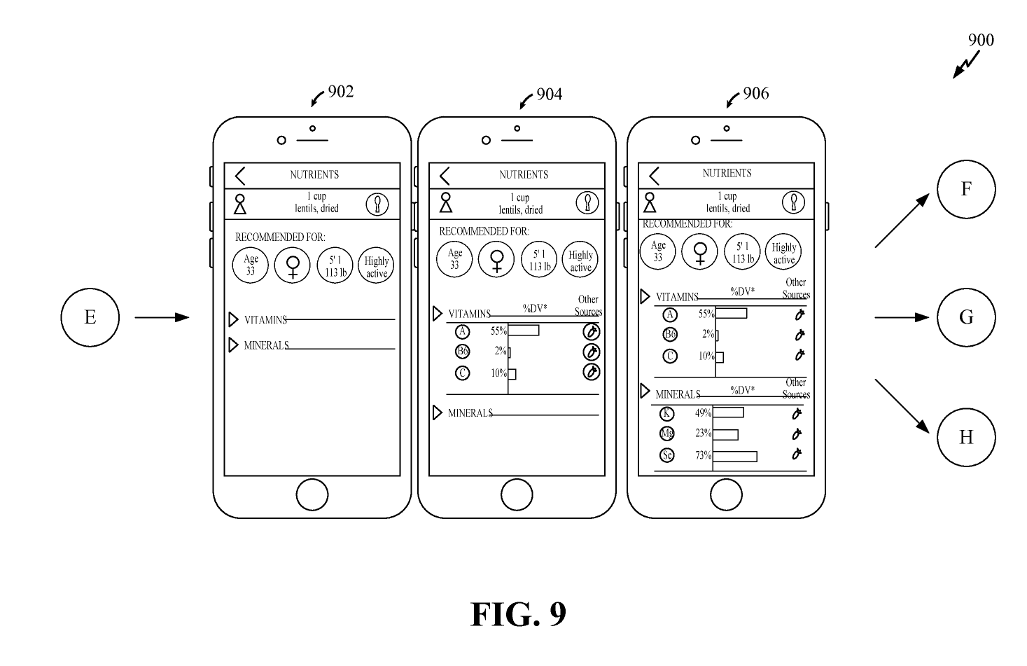

FIG. 9 is a diagram 900 illustrating an example of various aspects that may be provided to the user of the client device according to various aspects of the present disclosure. In some circumstances, the user may select one or more of the foods described above or illustrated in the drawings. After doing so, the user may be provided with the percent daily value of vitamins and/or minerals associated for that food based on at least one of age, gender, height, weight, or one or more lifestyle factors (e.g., activity level) of the user. For example, referring to the example illustrated in aspects 902, 904, 906 of FIG. 9, the user may be provided with the percent daily value of certain vitamins (e.g., A, B6, C) and/or certain minerals (e.g., K, Mg, Se) based on the age, gender, height, weight, and one or more lifestyle factors (e.g., activity level) of the user. For illustrative purposes, as shown in an aspect 906 of FIG. 9, a 33-year-old female that is 5′ 1″, weighs 113 lbs, and is highly active may be provided with information indicating that lentils (1 cup) contains 55% DV of vitamin A, 2% DV of vitamin B6, 10% DV of vitamin C, 49% DV of potassium, 23% DV of magnesium, and 73% of Se.

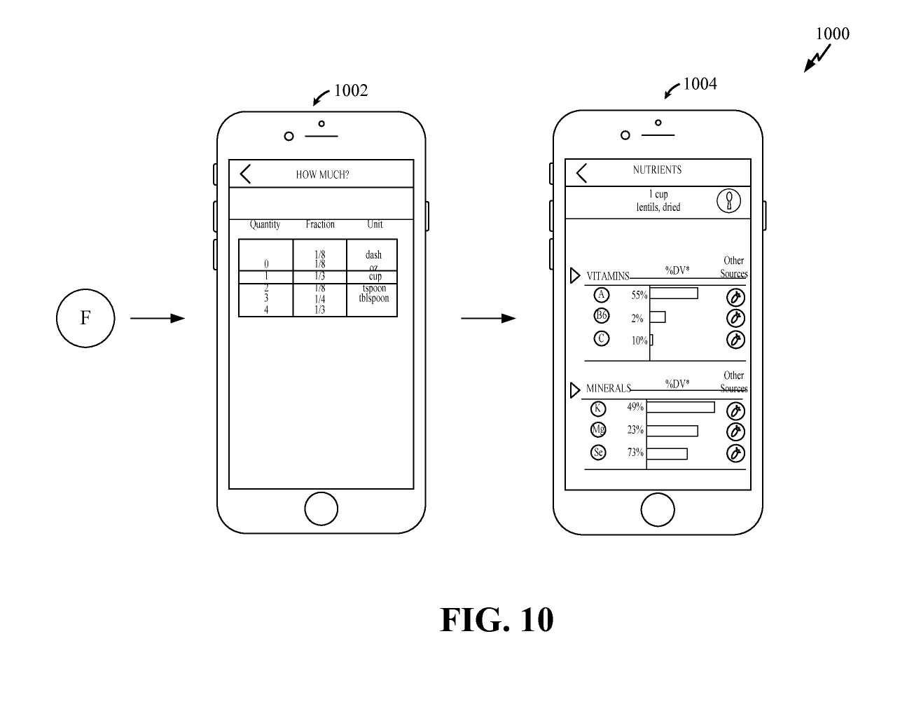

FIG. 10 is a diagram 1000 illustrating an example of various aspects that may be provided to the user of the client device according to various aspects of the present disclosure. As described above with reference to aspects 902, 904, 906 of FIG. 9, under some circumstances, the user may be provided with certain recommendations based on the age, gender, height, weight, and one or more lifestyle factors (e.g., activity level) of the user. In some circumstances, the user may select an amount of a particular food (e.g., lentils). For example, the user may be able to enter the quantity (e.g., integer values and/or fractions) as well as the unit (e.g., dash, ounce, cup, teaspoon, tablespoon, etc.) associated with that amount of food (e.g., lentils), as illustrated in an aspect 1002 of FIG. 10. After doing so, the user may be provided with the percent daily value of vitamins and/or minerals associated for that food. For example, referring to the example illustrated in an aspect 1004 of FIG. 10, the user may be provided with the percent daily value of certain vitamins (e.g., A, B6, C) and/or certain minerals (e.g., K, Mg, Se). For illustrative purposes, as shown in an aspect 1004 of FIG. 10, the user may be provided with information indicating that lentils (1 cup) contains 55% DV of vitamin A, 2% DV of vitamin B6, 10% DV of vitamin C, 49% DV of potassium, 23% DV of magnesium, and 73% of Se.

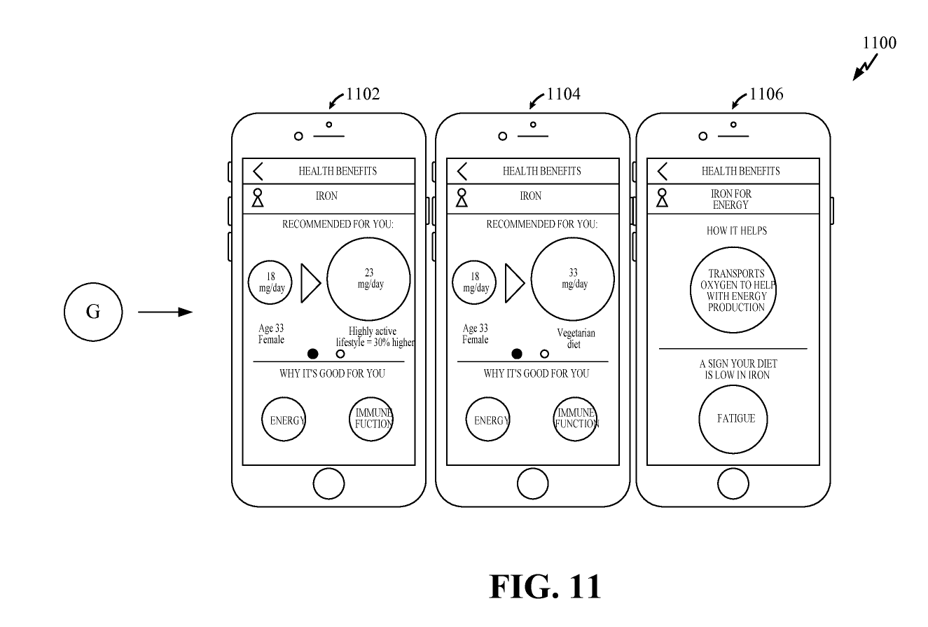

FIG. 11 is a diagram 1100 illustrating an example of various aspects that may be provided to the user of the client device according to various aspects of the present disclosure. As described above with reference to aspects 902, 904, 906 of FIG. 9, under some circumstances, the user may be provided with certain recommendations based on the age, gender, height, weight, and/or one or more lifestyle factors (e.g., activity level) of the user. The lifestyle factors may include any one or more of the following: the activity level of the user, whether the user is a smoker (and, if so, the daily/weekly tobacco consumption of the user), whether the user is a vegetarian, the daily work environment of the user (e.g., sedentary vs. active), the daily/weekly alcohol consumption of the user, a stress level of the user, and various other suitable factors that can be characterized as lifestyle factors by one of ordinary skill in the art. In some circumstances, the user may be a smoker. In an aspect, the user may be provided with a recommendation of vitamin C consumption that is higher than a recommendation of vitamin C consumption for a non-smoker. In some circumstances, the user may select a particular nutrient (e.g., iron). In an aspect 1102 of FIG. 11, the user may be provided with various options for the recommended amount of that nutrient (e.g., iron) based on the activity level of the user. For example, the user may be provided with a first recommendation of 18 mg/day of iron for an activity level that is not considered ‘high,’ and the user may also be provided with a second recommendation of 23 mg/day for an activity level that is considered ‘high.’ In another aspect 1104 of FIG. 11, the user may be provide with various options for the recommended amount of that nutrient (e.g., iron) based on whether the user is vegetarian. For example, the user may be provided with a first recommendation of 18 mg/day when the user is not vegetarian, and the user may be provided with a second recommendation of 33 mg/day when the user is vegetarian. In such aspects 1102, 1104, the user may be provided with options that provide opportunities for the user to seek additional information about the health benefits associated with that nutrient (e.g., iron). For example, as illustrated in aspects 1102, 1104 of FIG. 11, the user may be provided with opportunities to seek information about the health benefits of “energy” and/or “immune function” associated with iron. If the user seeks information about the health benefits of “energy,” the user may be provided with additional information describing certain health benefits as well as certain symptoms of a lack/deprivation of that nutrient. For instance, as illustrated in an aspect 1106 of FIG. 11, the user may be provided with information about “how it helps” (e.g., iron “transports oxygen to help with energy production”) and/or “a sign your diet is low in iron” (e.g., “fatigue”).

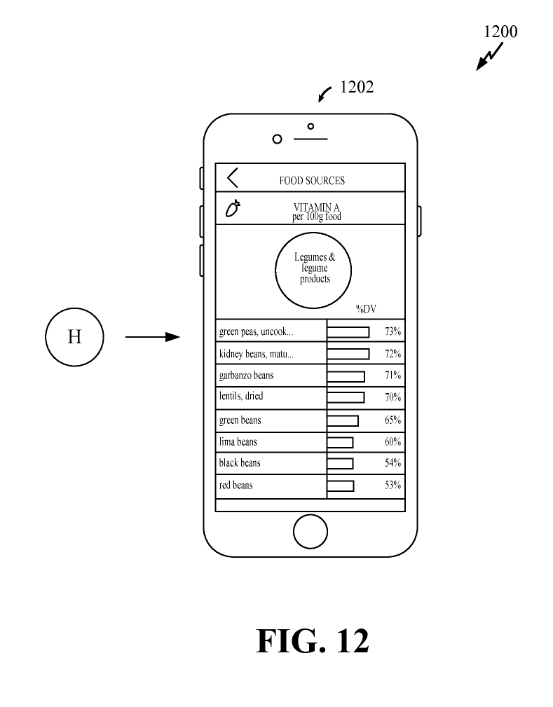

FIG. 12 is a diagram 1200 illustrating an example of various aspects that may be provided to the user of the client device according to various aspects of the present disclosure. As described above with reference to aspects 902, 904, 906 of FIG. 9, under some circumstances, the user may be provided with certain recommendations based on the age, gender, height, weight, and/or one or more lifestyle factors (e.g., activity level) of the user. In some circumstances, the user may select a particular nutrient (e.g., vitamin A). In an aspect 1202 of FIG. 12, the user may be provided with a ranked list of a plurality of foods (e.g., green peas, kidney beans, garbanzo beans, lentils, green beans, lima beans, black beans, red beans) that contain one or more nutrients (e.g., vitamin A). In some configurations, the list may be ranked according to a recommended percentage daily value (% DV) for the one or more nutrients (e.g., vitamin A). For example, garbanzo beans may be ranked higher in the list relative to the ranking of lentils in the list, because 71% DV of vitamin A in 100 grams of garbanzo beans is greater than the 70% DV of vitamin A in 100 grams of lentils. Although the example illustrated an aspect 1202 of FIG. 12 shows a ranked list based on a descending % DV associated with each food, one of ordinary skill in the art will understand that the ranked list may be provided in any other ranking configuration without deviating from the scope of the present disclosure.

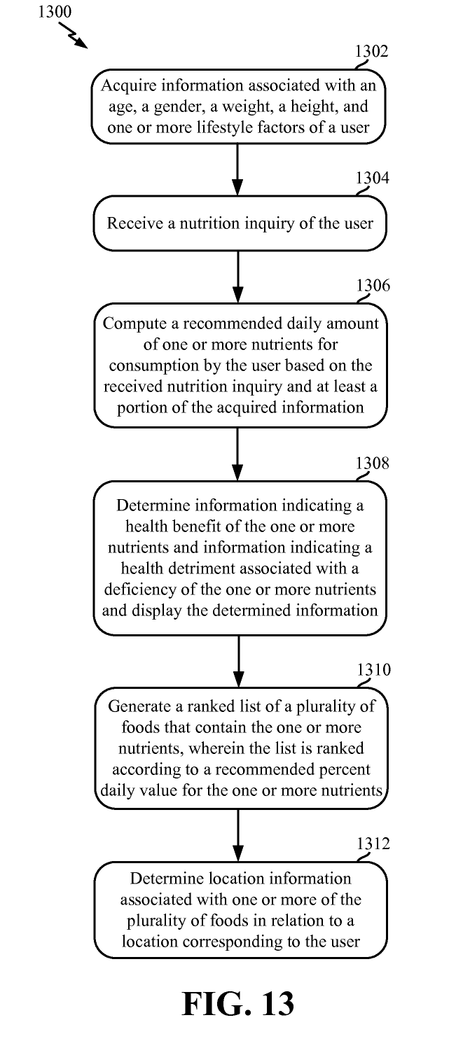

FIG. 13 is a diagram 1300 illustrating an example of various methods and/or processes performed by the device. In some configurations, such a device may be a client device (e.g., a smartphone 110), as described in greater detail herein. In some configurations, such a device may be a server device (e.g., server 102), as described in greater detail herein.

At block 1302, the device may acquire information associated with an age, a gender, a weight, a height, and/or one or more lifestyle factors (e.g., an activity level) of a user. In some configurations, such information may be input by the user. For example, the user may input their age, gender, weight, height, and/or one or more lifestyle factors (e.g., activity level) upon signing up or registering for the services provided by the system. In some configurations, such information may be retrieved from a server without requiring the user's input. For example, such information may be retrieved from a secure server that stores medical information about the user (e.g., from a secure server associated with the user's doctor or hospital).

At block 1304, the device may receive a nutrition inquiry of the user. For example, referring to aspects 402, 404, 406, 408 of FIG. 4, the user may input a nutrition inquiry. For example, as described above with reference to aspects 402, 404, 406, 408 of FIG. 4, the nutrition inquiry may include a nutrition inquiry about “vitamin A,” energy,” and/or “lentils.”

At block 1306, the device may compute a recommended daily amount of one or more nutrients for consumption by the user based on the received nutrition inquiry and at least a portion of the acquired information. For example, referring to an aspect 502 of FIG. 5, the device may compute a recommended daily amount of 700 mcg/day of vitamin A, which is based on the user's nutrition inquiry (as illustrated in an aspect 404 of FIG. 4) regarding “vitamin A” and at least a portion of the acquired information. As another example, referring to an aspect 602 of FIG. 6, the device may compute a recommended daily amount of 18 mg/day of Mg, vitamin B12, and Fe, which is based on the user's nutrition inquiry (as illustrated in an aspect 406 of FIG. 4) regarding “energy” and at least a portion of the acquired information.

At block 1308, the device may determine information indicating a health benefit of the one or more nutrients and information indicating a health detriment associated with a deficiency of the one or more nutrients and display the determined information. For example, referring to an aspect 502 of FIG. 5, the device may determine (and subsequently display) information indicating a health benefit of vitamin A (as shown under “why it's good for you”) as improving “immune function” and “eye health.” As another example, referring to an aspect 504 of FIG. 5, the device may determine (and subsequently display) information indicating a health benefit of vitamin A (as shown under “how it helps”) as “helps process vision to your brain.” Additionally, the device may determine (and subsequently display) information indicating a health detriment associated with a deficiency of vitamin A (as shown under “diets low in vitamin A lead to”) as possibly leading to “vision impairment.” Determining the health benefit(s) and/or health detriment(s) may be performed utilizing various techniques without deviating from the scope of the present disclosure. For example, this determination may include utilizing a look-up table, retrieving information based on various algorithms (e.g., mathematical equations), and/or any other suitable technique.

At block 1310, the device may generate a ranked list of a plurality of foods that contain the one or more nutrients, wherein the list is ranked according to a recommended percent daily value for the one or more nutrients. For example, referring to an aspect 506 of FIG. 5, the device may generate a ranked list of a plurality of foods (e.g., green peas, kidney beans, garbanzo beans, lentils, green beans, lima beans, black beans, red beans) that contain one or more nutrients (e.g., vitamin A). In some configurations, the list may be ranked according to a recommended percentage daily value (% DV) for the one or more nutrients (e.g., vitamin A). For example, garbanzo beans may be ranked higher in the list relative to the ranking of lentils in the list, because 71% DV of vitamin A in 100 grams of garbanzo beans is greater than the 70% DV of vitamin A in 100 grams of lentils. Although the example illustrated in an aspect 506 of FIG. 5 shows a ranked list based on a descending % DV associated with each food, one of ordinary skill in the art will understand that the ranked list may be provided in any other ranking configuration without deviating from the scope of the present disclosure.

In some configuration, the list is ranked according to a first set of one or more nutrients for which an increased consumption is recommended and a second set of one or more nutrients for which a decreased daily consumption is recommended. The first set may include one or more nutrients for which the increase or maximization thereof may provide health benefits to the user. An example of such a nutrient is potassium (K). The second set may include one or more nutrients for which the reduction or minimization thereof may provide health benefits to the user. An example of such a nutrient is sugar. Various mathematical equations and/or software algorithm may be implemented to achieve the desired outcome of increasing/maximizing the first set of one or more nutrients while reducing/minimizing the second set of one or more nutrients. An example of a pseudo-code that may implement such an outcome may be: max(first set of one or more nutrients) AND min(second set of one or more nutrients).

In some configurations, the list is ranked according to an average of the recommended percent daily value for two or more nutrients. In some configurations, the recommended daily amount of the one or more nutrients is computed further based on the acquired information associated with the age, the gender, the weight, and/or the one or more lifestyle factors (e.g., the activity level) of the user.

At block 1312, the device may determine location information associated with one or more of the plurality of foods in relation to a location corresponding to the user. Generally, the term ‘location information’ may refer to geolocation information, position information, altitude/elevation information, and other suitable types of location-based information that may be ascertained using various techniques, such as techniques that utilize a Global Positioning System (GPS), satellites, signal triangulation, cellular signals, Internet protocol (IP) address information (e.g., of the user), physical/mailing address information (e.g., of the user), and other suitable types of information. For example, after the device identifies consumer food products that suit the individual needs of the user, the device may help the user find a nearby location where such food products can be obtained (e.g., purchased). As another example, after the device identifies consumer food products that suit the individual needs of the user, the device may identify one or more sources (e.g., online marketplace(s)) that offer the option to deliver those food products to a location desired by the user.

One of ordinary skill in the art will understand that the sequence and order of operations described herein are provided for illustrative purposes and shall not be construed as a limitation of the present disclosure. The methods and/or processes described with reference to FIG. 13 are provided for illustrative purposes and are not intended to limit the scope of the present disclosure. The methods and/or processes described with reference to FIG. 13 may be performed in sequences different from those illustrated therein without deviating from the scope of the present disclosure. Additionally, some or all of the methods and/or processes described with reference to FIG. 13 may be performed individually and/or together without deviating from the scope of the present disclosure. It is to be understood that the specific order or hierarchy of steps in the methods disclosed is an illustration of exemplary processes. Based upon design preferences, it is understood that the specific order or hierarchy of steps in the methods may be rearranged. The accompanying claims present elements of the various steps in a sample order, and are not meant to be limited to the specific order or hierarchy presented unless specifically recited therein.

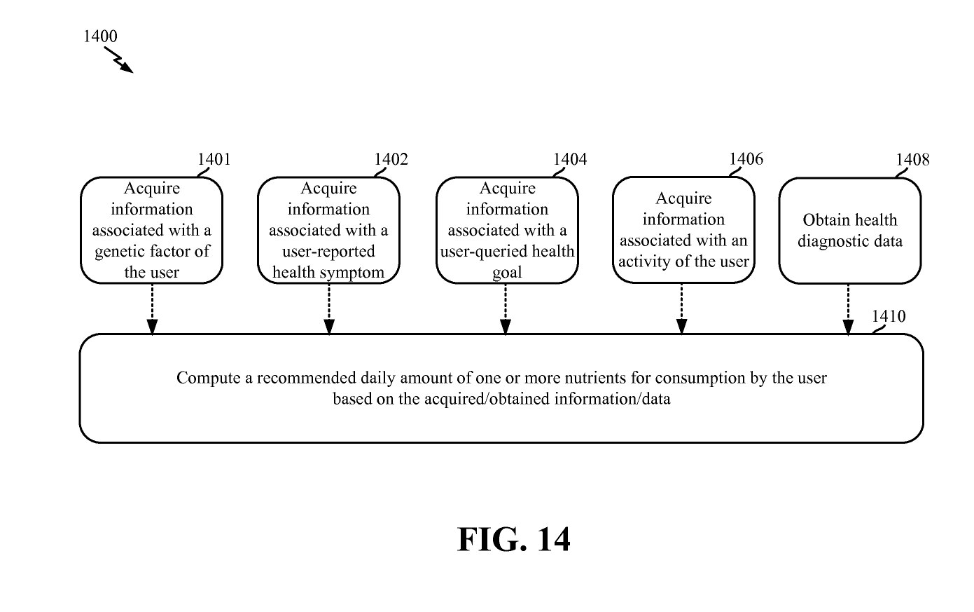

FIG. 14 is a diagram 1400 illustrating an example of various methods and/or processes performed by the device. In some configurations, such a device may be a client device (e.g., a smartphone 110), as described in greater detail herein. In some configurations, such a device may be a server device (e.g., server 102), as described in greater detail herein.

At block 1401, the device may acquire information associated with a genetic factor of the user. The term ‘genetic factor’ may refer to any information associated with the genetic information, genetic profile, genetic composition, genetic background, and/or genetic test result of the user. In some configurations, the recommended daily amount of the one or more nutrients for consumption by the user is computed based on the acquired information associated with the genetic factor of the user. For example, genetic testing results may reveal that the user should consider a particular genetic factor with regard to their food consumption. That genetic factor may indicate that the user is at risk of being deficient with regard to a particular nutrient. Accordingly, the device can adjust, modify, and/or otherwise compute the recommended daily amount of the one or more nutrients for consumption by the user based on that information associated with the genetic factor(s) of the user. The foregoing is merely one example of the use of the genetic factor(s) of the user. One of ordinary skill in the art will understand that various other examples pertaining to the use of the genetic factor(s) of the user may be implemented without deviating from the scope of the present disclosure.

At block 1402, the device may acquire information associated with a user-reported health symptom. For instance, the user may suffer from the illness known as the common cold. In some configurations, such information may be input by the user. In some configurations, the user may input their health symptoms upon signing up or registering for the services provided by the system. In some configurations, such information may be retrieved from a server without requiring the user's input. For example, such information may be retrieved from a secure server that stores medical information about the user (e.g., from a secure server associated with the user's doctor or hospital). At block 1410, the device may compute a recommended daily amount of one or more nutrients for consumption by the user based on the acquired information. For example, the device may recommend consumption of an elevated daily amount of vitamin C, which is greater than the otherwise appropriate daily amount of vitamin C, in order to allow the user an increased likelihood of overcoming their health symptoms (e.g., symptoms of the common cold).

At block 1404, the device may acquire information associated with a user-queried health goal. For example, the device may ask the user to input a target amount of calories that the user wishes to burn in a particular period of time (e.g., in a single day). As another example, the device may ask the user to input a target amount of weight that the user wishes to loses in a particular period of time (e.g., a month). As yet another example, the device may ask the user to input a target amount of vitamin A that the user wishes to ingest during a particular period of time (e.g., in a single week). At block 1410, the device may compute a recommended daily amount of one or more nutrients for consumption by the user based on the acquired information. For example, if the user's goal includes burning more calories and/or losing weight, the device may recommend consumption of an elevated daily amount of certain vitamins, minerals, and/or other supplemental foods that are associated with increased metabolism and/or appetite suppression.

At block 1406, the device may acquire information associated with an activity of the user. For example, the user may report that their activity level is high (in relation to a suitable baseline). At block 1410, the device may compute a recommended daily amount of one or more nutrients for consumption by the user based on the acquired information. For example, referring to an aspect 1102 of FIG. 11, the device may recommend that the user consume 30% more iron (in relation to a suitable baseline) because the user has reported that their activity level is high (in relation to a suitable baseline). For instance, the device may recommend consumption of 23 mg/day of iron, instead of 18 mg/day of iron, as shown in an aspect 1102 of FIG. 11. In some configurations, a nutrition expert (e.g., an RDN) may provide an input that causes the device to recommend consumption of 23 mg/day of iron, instead of 18 mg/day of iron.

One of ordinary skill in the art will understand that the sequence and order of operations described herein are provided for illustrative purposes and shall not be construed as a limitation of the present disclosure. The methods and/or processes described with reference to FIG. 14 are provided for illustrative purposes and are not intended to limit the scope of the present disclosure. The methods and/or processes described with reference to FIG. 14 may be performed in sequences different from those illustrated therein without deviating from the scope of the present disclosure. Additionally, some or all of the methods and/or processes described with reference to FIG. 14 may be performed individually and/or together without deviating from the scope of the present disclosure. It is to be understood that the specific order or hierarchy of steps in the methods disclosed is an illustration of exemplary processes. Based upon design preferences, it is understood that the specific order or hierarchy of steps in the methods may be rearranged. The accompanying claims present elements of the various steps in a sample order, and are not meant to be limited to the specific order or hierarchy presented unless specifically recited therein.

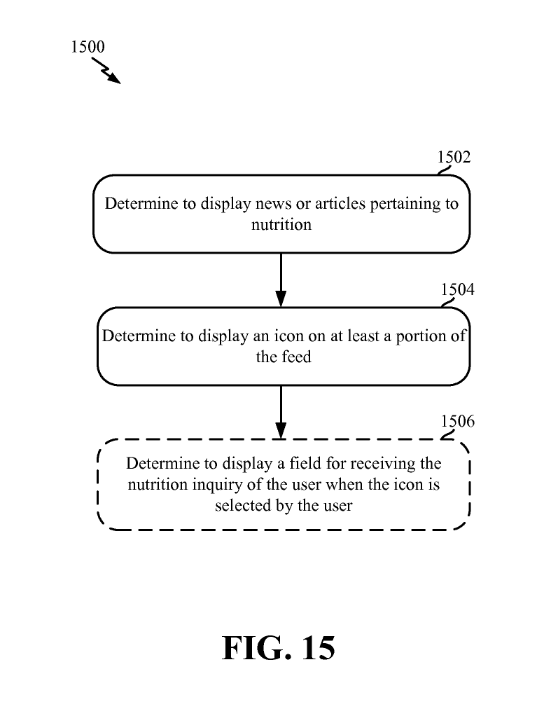

FIG. 15 is a diagram 1500 illustrating an example of various methods and/or processes performed by the device. In some configurations, such a device may be a client device (e.g., a smartphone 110), as described in greater detail herein. In some configurations, such a device may be a server device (e.g., server 102), as described in greater detail herein.

At block 1502, the device may determine to display news or articles pertaining to nutrition. For example, referring to aspects 302, 304 of FIG. 3, the device may display a news feed. The news feed may provide the user with continuously updating content associated with nutrition. The content associated with nutrition may include news, articles, blog posts, and any other suitable information associated with nutrition. In some configurations, the content associated with nutrition may be retrieved from a server, a website, a database, or other suitable source of information associated with nutrition. In some configurations, the content associated with nutrition may be provided by nutritionists, such as registered dietitian nutritionists (RDNs), or any other suitable person or entity that provides information associated with nutrition. For example, as illustrated in an aspect 302 of FIG. 3, one content may be titled, “lentil soup for the soul,” and another content may be titled, “10 ways to use quinoa.” If the user selects the content titled “lentil soup for the soul,” the user may be provided with the display shown in an aspect 304 of FIG. 3. In the aspect 304 illustrated in FIG. 3, the user is provided more information pertaining to that selected content. For example, the user may view the recipe associated with “lentil soup for the soul,” and the user may have various other options for communicating and commenting about that content (“lentil soup for the soul”). For instance, the user may “like” that content, comment on that article, repost that content, and/or perform various other suitable actions associated with that content.

At block 1504, the device may determine to display an icon on at least a portion of the feed. For example, referring to an aspect 302 of FIG. 3, the device may determine to display the carrot-shaped icon (e.g., the “Seek It” icon) shown on the image having the text, “lentil soup for the soul.” At block 1506, the device may determine to display a field for receiving the nutrition inquiry of the user when the icon is selected by the user. For example, referring to an aspect 402 of FIG. 4, the device may display a search bar for the user to provide their nutrition inquiry. The search bar may be located near an icon (e.g., the “Seek It” icon).

In some configurations, as described in an aspect 302 of FIG. 3, such an icon (e.g., the “Seek It” icon) may be located on or adjacent to at least a portion of the news or articles of the news feed. In some configurations, selecting that icon (e.g., the “Seek It” icon) anywhere on the aspect 302 illustrated in FIG. 3 may trigger the search operations described herein (e.g., with reference to FIG. 4). For instance, the user may select the icon (e.g., the “Seek It” icon) that is located on the content titled, “lentil soup for the soul.” When that icon is selected by the user, the device may automatically populate the field for receiving the nutrition inquiry with a search phrase that corresponds to the displayed news or articles pertaining to nutrition. For example, referring to an aspect 408 of FIG. 4, the device may automatically populate the search bar with a search phrase (“lentils”) that corresponds to that displayed news or article (which was titled, “lentil soup for the soul”).

One of ordinary skill in the art will understand that the sequence and order of operations described herein are provided for illustrative purposes and shall not be construed as a limitation of the present disclosure. The methods and/or processes described with reference to FIG. 15 are provided for illustrative purposes and are not intended to limit the scope of the present disclosure. The methods and/or processes described with reference to FIG. 15 may be performed in sequences different from those illustrated therein without deviating from the scope of the present disclosure. Additionally, some or all of the methods and/or processes described with reference to FIG. 15 may be performed individually and/or together without deviating from the scope of the present disclosure. It is to be understood that the specific order or hierarchy of steps in the methods disclosed is an illustration of exemplary processes. Based upon design preferences, it is understood that the specific order or hierarchy of steps in the methods may be rearranged. The accompanying claims present elements of the various steps in a sample order, and are not meant to be limited to the specific order or hierarchy presented unless specifically recited therein.

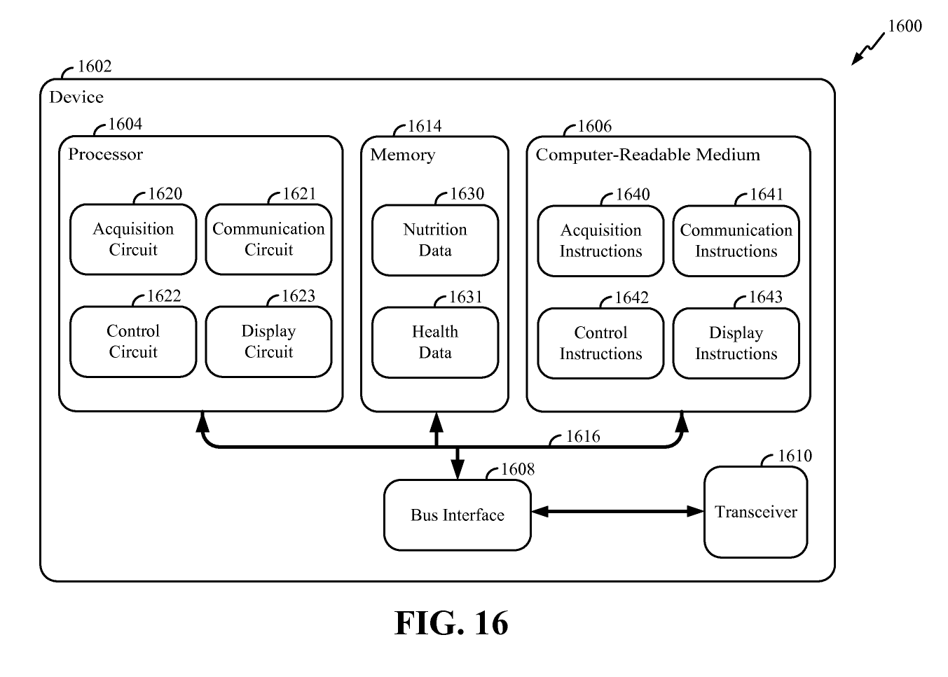

FIG. 16 is a diagram 1600 illustrating an example of hardware implementation of a device. In some configurations, such a device may be a client device (e.g., a smartphone 110), as described in greater detail herein. In some configurations, such a device may be a server device (e.g., server 102), as described in greater detail herein. The device 1602 may include a transceiver 1610. The transceiver 1610 may be configured to receive data and/or transmit data in communication with another apparatus. The transceiver 1610 provides a means for communicating with another apparatus via a wired or wireless transmission medium. The transceiver 1610 may be configured to perform such communications using various types of technologies. One of ordinary skill in the art will understand that many types of technologies may perform such communication without deviating from the scope of the present disclosure. The device 1602 may also include a memory 1614, one or more processors 1604, a computer-readable medium 1606, and a bus interface 1608. The bus interface 1608 may provide an interface between a bus 1616 and the transceiver 1610. The memory 1614, the one or more processors 1604, the computer-readable medium 1606, and the bus interface 1608 may be connected together via the bus 1616. The processor 1604 may be communicatively coupled to the transceiver 1610 and/or the memory 1614.

The processor 1604 may include an acquisition circuit 1620. The acquisition circuit 1620 may be configured to acquire information associated with an age, a gender, a weight, a height, and one or more lifestyle factors (e.g., an activity level) of a user. The acquisition circuit 1620 may include hardware components that provide the means for acquiring information associated with an age, a gender, a weight, a height, and one or more lifestyle factors (e.g., an activity level) of a user. The acquisition circuit 1620 may also include software modules that provide algorithms for acquiring information associated with an age, a gender, a weight, a height, and one or more lifestyle factors (e.g., an activity level) of a user.

The processor 1604 may also include a communication circuit 1621. The communication circuit 1621 may be configured to receive a nutrition inquiry of the user. The communication circuit 1621 may include hardware components that provide the means for receiving a nutrition inquiry of the user. The communication circuit 1621 may also include software modules that provide algorithms for receiving a nutrition inquiry of the user.

The processor 1604 may also include a control circuit 1622. The control circuit 1622 may be configured to compute a recommended daily amount of one or more nutrients for consumption by the user based on the received nutrition inquiry and at least a portion of the acquired information. The control circuit 1622 may include hardware components that provide the means for computing a recommended daily amount of one or more nutrients for consumption by the user based on the received nutrition inquiry and at least a portion of the acquired information. The control circuit 1622 may also include software modules that provide algorithms for computing a recommended daily amount of one or more nutrients for consumption by the user based on the received nutrition inquiry and at least a portion of the acquired information.

The control circuit 1622 may be further configured to determine information indicating a health benefit of the one or more nutrients and information indicating a health detriment associated with a deficiency or excess of the one or more nutrients and to display the determined information. The control circuit 1622 may include hardware components that provide the means for determining information indicating a health benefit of the one or more nutrients and information indicating a health detriment associated with a deficiency or excess of the one or more nutrients and displaying the determined information. The control circuit 1622 may also include software modules that provide algorithms for determining information indicating a health benefit of the one or more nutrients and information indicating a health detriment associated with a deficiency or excess of the one or more nutrients and displaying the determined information.

In some configurations, the acquisition circuit 1620 may be further configured to acquire information associated with a user-queried health goal, wherein the recommended daily amount of the one or more nutrients is computed further based on the acquired information associated with the user-queried health goal. The acquisition circuit 1620 may include hardware components that provide the means for acquiring information associated with a user-queried health goal, wherein the recommended daily amount of the one or more nutrients is computed further based on the acquired information associated with the user-queried health goal. The acquisition circuit 1620 may also include software modules that provide algorithms for acquiring information associated with a user-queried health goal, wherein the recommended daily amount of the one or more nutrients is computed further based on the acquired information associated with the user-queried health goal.

In some configurations, the acquisition circuit 1620 may be further configured to acquire information associated with a user-reported health symptom, wherein the recommended daily amount of the one or more nutrients is computed further based on the acquired information associated with the user-reported health symptom. The acquisition circuit 1620 may include hardware components that provide the means for acquiring information associated with a user-reported health symptom, wherein the recommended daily amount of the one or more nutrients is computed further based on the acquired information associated with the user-reported health symptom. The acquisition circuit 1620 may also include software modules that provide algorithms for acquiring information associated with a user-reported health symptom, wherein the recommended daily amount of the one or more nutrients is computed further based on the acquired information associated with the user-reported health symptom.

In some configurations, the acquisition circuit 1620 may be further configured to acquire information associated with an activity of the user, wherein the recommended daily amount of the one or more nutrients is further based on the acquired information associated with the activity of the user. The acquisition circuit 1620 may include hardware components that provide the means for acquiring information associated with an activity of the user, wherein the recommended daily amount of the one or more nutrients is further based on the acquired information associated with the activity of the user. The acquisition circuit 1620 may also include software modules that provide algorithms for acquiring information associated with an activity of the user, wherein the recommended daily amount of the one or more nutrients is further based on the acquired information associated with the activity of the user.

In some configurations, the acquisition circuit 1620 may be further configured to obtain health diagnostic data, wherein the recommended daily amount of the one or more nutrients is further based on the acquired information associated with the activity of the user. The acquisition circuit 1620 may include hardware components that provide the means obtaining health diagnostic data, wherein the recommended daily amount of the one or more nutrients is further based on the acquired information associated with the activity of the user. The acquisition circuit 1620 may also include software modules that provide algorithms for obtaining health diagnostic data, wherein the recommended daily amount of the one or more nutrients is further based on the acquired information associated with the activity of the user.

The processor 1604 may also include a display circuit 1623. The display circuit 1623 may be configured to generate a ranked list of a plurality of foods that contain the one or more nutrients, wherein the list is ranked according to a recommended percent daily value for the one or more nutrients. The display circuit 1623 may include hardware components that provide the means for generating a ranked list of a plurality of foods that contain the one or more nutrients, wherein the list is ranked according to a recommended percent daily value for the one or more nutrients. The display circuit 1623 may also include software modules that provide algorithms for generating a ranked list of a plurality of foods that contain the one or more nutrients, wherein the list is ranked according to a recommended percent daily value for the one or more nutrients. The display circuit 1623 may include hardware components that provide the means for determining location information associated with one or more of the plurality of foods in relation to a location corresponding to the user. The display circuit 1623 may also include software modules that provide algorithms for determining location information associated with one or more of the plurality of foods in relation to a location corresponding to the user.

In some configurations, the display circuit 1623 may be configured to determine to display news or articles pertaining to nutrition, determine to display an icon on at least a portion of the feed, and determine to display a field for receiving the nutrition inquiry of the user when the icon is selected by the user. The display circuit 1623 may include hardware components that provide the means for determining to display news or articles pertaining to nutrition, means for determining to display an icon on at least a portion of the feed, and means for determining to display a field for receiving the nutrition inquiry of the user when the icon is selected by the user. The display circuit 1623 may also include software modules that provide algorithms for determining to display news or articles pertaining to nutrition, determining to display an icon on at least a portion of the feed, and determining to display a field for receiving the nutrition inquiry of the user when the icon is selected by the user.

In some configurations, the display circuit 1623 may be configured to automatically populate the field for receiving the nutrition inquiry with a search phrase that corresponds to the displayed news or articles pertaining to nutrition, when the icon is selected by the user. The display circuit 1623 may include hardware components that provide the means for automatically populating the field for receiving the nutrition inquiry with a search phrase that corresponds to the displayed news or articles pertaining to nutrition, when the icon is selected by the user. The display circuit 1623 may also include software modules that provide algorithms for automatically populating the field for receiving the nutrition inquiry with a search phrase that corresponds to the displayed news or articles pertaining to nutrition, when the icon is selected by the user.

The computer-readable medium 1606 may include various computer-executable instructions. The computer-executable instructions may include computer-executable code configured to perform various functions and/or enable various aspects described herein. The computer-executable instructions may be executed by various hardware components (e.g., processor 1604) of the device 1602. The instructions may be a part of various software programs and/or software modules.

The computer-readable medium 1606 may include acquisition instructions 1640. The acquisition instructions 1640 may include computer-executable instructions configured to acquire information associated with an age, a gender, a weight, a height, and one or more lifestyle factors (e.g., an activity level) of a user. The computer-readable medium 1606 may also include communication instructions 1641. The communication instructions 1641 may be configured to receive a nutrition inquiry of the user. The computer-readable medium 1606 may include control instructions 1642. The control instructions may be configured to compute a recommended daily amount of one or more nutrients for consumption by the user based on the received nutrition inquiry and at least a portion of the acquired information. The control instructions 1642 may be further configured to determine information indicating a health benefit of the one or more nutrients and information indicating a health detriment associated with a deficiency or excess of the one or more nutrients and to display the determined information.

In some configurations, the acquisition instructions 1640 may be configured to acquire information associated with a user-queried health goal, wherein the recommended daily amount of the one or more nutrients is computed further based on the acquired information associated with the user-queried health goal. In some configurations, the acquisition instructions 1640 may be configured to acquire information associated with a user-reported health symptom, wherein the recommended daily amount of the one or more nutrients is computed further based on the acquired information associated with the user-reported health symptom. In some configurations, the acquisition instructions 1640 may be configured to acquire information associated with an activity of the user, wherein the recommended daily amount of the one or more nutrients is further based on the acquired information associated with the activity of the user. In some configurations, the acquisition instructions 1640 may be configured to obtain health diagnostic data, wherein the recommended daily amount of the one or more nutrients is further based on the acquired information associated with the activity of the user.

The computer readable medium 1606 may also include display instructions 1643. The display instructions 1643 may be configured to generate a ranked list of a plurality of foods that contain the one or more nutrients, wherein the list is ranked according to a recommended percent daily value for the one or more nutrients. The display instructions 1643 may be configured to determine location information associated with one or more of the plurality of foods in relation to a location corresponding to the user. In some configurations, the display instructions 1643 may be further configured to determine to display news or articles pertaining to nutrition, determine to display an icon on at least a portion of the feed, and determine to display a field for receiving the nutrition inquiry of the user when the icon is selected by the user. In some configurations, the display instructions 1643 may be further configured to automatically populate the field for receiving the nutrition inquiry with a search phrase that corresponds to the displayed news or articles pertaining to nutrition, when the icon is selected by the user.

The memory 1614 may include various memory modules. The memory modules may be configured to store, and have read therefrom, various values and/or information by the processor 1604, or any of its circuits 1620, 1621, 1622, 1623. The memory modules may also be configured to store, and have read therefrom, various values and/or information upon execution of the computer-executable code included in the computer-readable medium 1606, or any of its instructions 1640, 1641, 1642, 1643. The memory 1614 may include nutrition data 1630. The nutrition data 1630 may include any information associated with the nutritional content various foods, as described in greater detail herein. The memory 1614 may also include health data. The health data 1631 may include information associated with the health benefit(s) of increasing consumption of a particular nutrient as well as the health detriment(s) of a lack or an excess of a particular nutrient, as described in greater detail herein. The foregoing is an example of some data included in the memory 1614 of the device 1602. One of ordinary skill in the art will understand that the memory 1614 may also include various other data (not shown) that is in addition and/or alternative to the aforementioned data 1630, 1631. Such other data (not shown) may include data performing any one or more of the functions, methods, processes, features and/or aspects described herein.

One of ordinary skill in the art will also understand that the device 1602 may include alternative and/or additional features without deviating from the scope of the present disclosure. In accordance with various aspects of the present disclosure, an element, or any portion of an element, or any combination of elements may be implemented with a processing system that includes one or more processors 1604. Examples of the one or more processors 1604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. The processing system may be implemented with a bus architecture, represented generally by the bus 1616 and bus interface 1608. The bus 1616 may include any number of interconnecting buses and bridges depending on the specific application of the processing system and the overall design constraints. The bus 1616 may link together various circuits including the one or more processors 1604, the memory 1614, and the computer-readable media 1606. The bus 1616 may also link various other circuits such as timing sources, peripherals, voltage regulators, and power management circuits, which are well known in the art.

The one or more processors 1604 may be responsible for managing the bus 1616 and general processing, including the execution of software stored on the computer-readable medium 1606. The software, when executed by the one or more processors 1604, causes the processing system to perform the various functions described below for any one or more apparatuses. The computer-readable medium 1606 may also be used for storing data that is manipulated by the one or more processors 1604 when executing software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 1606. The computer-readable medium 1606 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1606 may also include, by way of example, a carrier wave, a transmission line, and any other suitable medium for transmitting software and/or instructions that may be accessed and read by a computer. The computer-readable medium 1606 may reside in the processing system, external to the processing system, or distributed across multiple entities including the processing system. The computer-readable medium 1606 may be embodied in a computer program product. By way of example and not limitation, a computer program product may include a computer-readable medium in packaging materials. Those skilled in the art will recognize how best to implement the described functionality presented throughout this disclosure depending on the particular application and the overall design constraints imposed on the overall system.

The foregoing description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

1. An apparatus for providing nutrition-related information to a user, wherein the apparatus comprises at least one processor and a memory communicatively coupled to the at least one processor, wherein the at least one processor is configured to:
acquire information associated with an age, a gender, a weight, a height, and one or more lifestyle factors of a user;
receive a nutrition inquiry of the user;
based on the received nutrition inquiry and at least a portion of the acquired information, compute a recommended daily amount of one or more nutrients for consumption by the user;
determine information indicating a health benefit of the one or more nutrients and information indicating a health detriment associated with a deficiency or excess of the one or more nutrients and to display the determined information;
generate a ranked list of a plurality of foods that contain the one or more nutrients, wherein the list is ranked according to a recommended percent daily value for the one or more nutrients; and
determine location information associated with one or more of the plurality of foods in relation to a location corresponding to the user.

2. The apparatus of claim 1, wherein the at least one processor is further configured to:
acquire information associated with a genetic factor of the user, wherein the recommended daily amount of the one or more nutrients for consumption by the user is computed further based on the acquired information associated with the genetic factor of the user.

3. The apparatus of claim 1, wherein:
the list is ranked according to a first set of one or more nutrients for which an increased daily consumption is recommended and a second set of one or more nutrients for which a decreased consumption daily consumption is recommended.

4. The apparatus of claim 1, wherein:
the list is ranked according to an average of the recommended percent daily value for two or more nutrients.

5. The apparatus of claim 1, wherein:
the recommended daily amount of the one or more nutrients is computed further based on the acquired information associated with the age, the gender, the weight, the height, and the one or more lifestyle factors of the user.

6. The apparatus of claim 4, wherein the at least one processor is further configured to:
acquire information associated with a user-queried health goal, wherein the recommended daily amount of the one or more nutrients is computed further based on the acquired information associated with the user-queried health goal.

7. The apparatus of claim 5, wherein the at least one processor is further configured to:
acquire information associated with a user-reported health symptom, wherein the recommended daily amount of the one or more nutrients is computed further based on the acquired information associated with the user-reported health symptom.

8. The apparatus of claim 5, wherein the at least one processor is further configured to:
acquire information associated with an activity of the user, wherein the recommended daily amount of the one or more nutrients is further based on the acquired information associated with the activity of the user.

9. The apparatus of claim 5, wherein the at least one processor is further configured to:
obtain health diagnostic data, wherein the recommended daily amount of the one or more nutrients is further based on the acquired information associated with the activity of the user.

10. The apparatus of claim 5, wherein the at least one processor is further configured to:
determine to display news or articles pertaining to nutrition;
determine to display an icon on at least a portion of the feed; and
determine to display a field for receiving the nutrition inquiry of the user when the icon is selected by the user.

11. The apparatus of claim 10, wherein the at least one processor is further configured to:
when the icon is selected by the user, automatically populating the field for receiving the nutrition inquiry with a search phrase that corresponds to the displayed news or articles pertaining to nutrition.

12. A method of providing nutrition-related information to a user, the method comprising:
acquiring information associated with an age, a gender, a weight, a height, and one or more lifestyle factors of a user;
receiving a nutrition inquiry of the user;
based on the received nutrition inquiry and at least a portion of the acquired information, computing a recommended daily amount of one or more nutrients for consumption by the user;
determining information indicating a health benefit of the one or more nutrients and information indicating a health detriment associated with a deficiency or excess of the one or more nutrients and displaying the determined information;
generating a ranked list of a plurality of foods that contain the one or more nutrients, wherein the list is ranked according to a recommended percent daily value for the one or more nutrients; and
determining location information associated with one or more of the plurality of foods in relation to a location corresponding to the user.

13. The method of claim 12, wherein:
the recommended daily amount of the one or more nutrients is computed further based on the acquired information associated with the age, the gender, the weight, the height, and the one or more lifestyle factors of the user; and
the list is ranked according to an average of the recommended percent daily value for two or more nutrients.

14. The method of claim 13, further comprising:
acquiring information associated with a genetic factor of the user, wherein the recommended daily amount of the one or more nutrients for consumption by the user is computed further based on the acquired information associated with the genetic factor of the user;
acquiring information associated with an activity of the user, wherein the recommended daily amount of the one or more nutrients is further based on the acquired information associated with the activity of the user; and
acquire information associated with a user-queried health goal, wherein the recommended daily amount of the one or more nutrients is computed further based on the acquired information associated with the user-queried health goal.

15. The method of claim 14, further comprising:
acquiring information associated with a user-reported health symptom, wherein the recommended daily amount of the one or more nutrients is computed further based on the acquired information associated with the user-reported health symptom; and
obtaining health diagnostic data, wherein the recommended daily amount of the one or more nutrients is further based on the acquired information associated with the activity of the user.

16. A non-transitory computer-readable medium comprising computer-executable instructions configured to:
acquire information associated with an age, a gender, a weight, a height, and an one or more lifestyle factors of a user;
receive a nutrition inquiry of the user;
based on the received nutrition inquiry and at least a portion of the acquired information, compute a recommended daily amount of one or more nutrients for consumption by the user;
determine information indicating a health benefit of the one or more nutrients and information indicating a health detriment associated with a deficiency or excess of the one or more nutrients and display the determined information;
generate a ranked list of a plurality of foods that contain the one or more nutrients, wherein the list is ranked according to a recommended percent daily value for the one or more nutrients; and
determine location information associated with one or more of the plurality of foods in relation to a location corresponding to the user.

17. The non-transitory computer-readable medium of claim 16, wherein:
the list is ranked according to a first set of one or more nutrients for which an increased daily consumption is recommended and a second set of one or more nutrients for which a decreased daily consumption is recommended; and
the recommended daily amount of the one or more nutrients is computed further based on the acquired information associated with the age, the gender, the weight, the height, and the one or more lifestyle factors of the user.

18. The non-transitory computer-readable medium of claim 17, wherein the computer-executable instructions are further configured to:
acquire information associated with a user-queried health goal, wherein the recommended daily amount of the one or more nutrients is computed further based on the acquired information associated with the user-queried health goal;
acquire information associated with a user-reported health symptom, wherein the recommended daily amount of the one or more nutrients is computed further based on the acquired information associated with the user-reported health symptom;
acquire information associated with an activity of the user, wherein the recommended daily amount of the one or more nutrients is further based on the acquired information associated with the activity of the user;
obtain health diagnostic data, wherein the recommended daily amount of the one or more nutrients is further based on the acquired information associated with the activity of the user; and
determine location information associated with one or more of the plurality of foods in relation to a location corresponding to the user.

19. The non-transitory computer-readable medium of claim 18, wherein the computer-executable instructions are further configured to:
determine to display news or articles pertaining to nutrition;
determine to display an icon on at least a portion of the feed;
determine to display a field for receiving the nutrition inquiry of the user when the icon is selected by the user; and
when the icon is selected by the user, automatically populate the field for receiving the nutrition inquiry with a search phrase that corresponds to the displayed news or articles pertaining to nutrition.

20. An apparatus for providing nutrition-related information to a user, wherein the apparatus comprises:
means for acquiring information associated with an age, a gender, a weight, a height, and one or more lifestyle factors of a user;
means for receiving a nutrition inquiry of the user;
means for computing, based on the received nutrition inquiry and at least a portion of the acquired information, a recommended daily amount of one or more nutrients for consumption by the user;
means for determining information indicating a health benefit of the one or more nutrients and information indicating a health detriment associated with a deficiency or excess of the one or more nutrients and display the determined information;
means for generating a ranked list of a plurality of foods that contain the one or more nutrients, wherein the list is ranked according to a recommended percent daily value for the one or more nutrients; and
means for determining location information associated with one or more of the plurality of foods in relation to a location corresponding to the user.
